(19) United States
(12) Patent Application Publication
(10) Pub. No.: US 2014/0359457 A1
(43) Pub. Date: Dec. 4, 2014

(54) USER PORTAL TO A HUB-BASED SYSTEM FEDERATING DISPARATE UNIFIED COMMUNICATIONS SYSTEMS

(71) Applicant: NextPlane, Inc., Sunnyvale, CA (US)

(72) Inventors: Saravanan Bellan, San Jose, CA (US); Farzin Shahidi, Los Altos Hills, CA (US); Venky Talla, Secunderabad (IN); Sanjay Pujare, San Jose, CA (US); Yogesh Raina, Cupertino, CA (US)

(73) Assignee: NextPlane, Inc., Sunnyvale, CA (US)

(21) Appl. No.: 13/906,311

(22) Filed: May 30, 2013

(51) Int. Cl. H04L 12/24

(52) U.S. Cl. CPC H04L 41/22
USPC 715/736

(57) ABSTRACT

An apparatus for managing connections of a hub-based federation system. The apparatus includes a user interface for receiving input from a user and a logic component for generating a checklist of action items based on the user input. The apparatus also includes a task manager for managing the checklist as a task and a hub interface for communicating with a hub capable of federating a plurality of unified communications systems.

### RELATED FIELD

The present disclosure relates in general to interconnecting unified communications systems, and in particular, to a user portal to a hub that interconnects disparate unified communications systems in a federated manner.

### BACKGROUND

A unified communications (“UC”) system generally refers to a system that provides users with an integration of communications services. Users typically connect to the UC system through a single client to access the integrated communications services. The integrated communications services may include real-time services, such as instant messaging (IM), presence notifications, telephony, and video conferencing, as well as non-real-time services, such as E-mail, SMS, fax, and voicemail.

Organizations, such as corporations, businesses, educational institutions, and government entities, often employ UC systems to enable internal communication among its members in a uniform and generally cost-efficient manner. In addition, organizations may employ UC systems for communicating with trusted external entities.

A number of third-party developers offer various UC applications for implementing UC systems. The various applications include Microsoft Lync (previously, Microsoft Office Communications Server (OCS)), IBM Sametime (ST), Google Apps, and Cisco Jabber. Because there is no industry standard regarding UC systems, issues of incompatibility arise when one UC system needs to communicate with a different UC system. In one case, a corporation or business that employs a particular UC system may desire to communicate externally with vendors or other persons who employ a different UC system. Or in the case of internal communication, when an organization that employs a particular UC system “A” merges with another organization that employs a UC system “B”, the ability for users on system “A” to communicate with users on system “B” is often desirable. Nevertheless, the incompatibility of the UC systems often makes communication between the UC systems difficult or impossible to implement.

Co-pending U.S. patent application Ser. No. 13/077,710 entitled “Hub Based Clearing House For Interoperatbility Of Distinct Unified Communications Systems” and U.S. patent application Ser. No. 13/153,025 entitled “Method And System For Advanced Alias Domain Routing,” incorporated by reference herein, describe a highly scalable, hub-based system for interconnecting, or federating, any number of disparate UC systems. The hub-based system includes a hub that allows users on one UC system to communicate with users of another UC system as if they were served by the same UC system in the same or different domain, whether the UC systems are of the same or different type. Connecting a UC system to the hub and ensuring that communication is established between them, or domain provisioning, often involves the hub administrator configuring the hub and telling the UC administrator how to configure the UC system based the specifics associated with the UC system. Furthermore, federating UC systems already provisioned with the hub to establish communication among them often involves the hub administrator telling the respective UC administrators how to configure their UC systems based on the specifics associated with the UC systems. This process becomes costly and inefficient as the number of domain provisioning and federating operations increases. Therefore, there exists a need for a system and method to facilitate federating multiple, disparate UC systems in an efficient manner.

### SUMMARY

An apparatus for managing connections of a hub-based federation system. The apparatus includes a user interface for receiving input from a user and a logic component for generating a checklist of action items based on the user input. The apparatus also includes a task manager for managing the checklist as a task and a hub interface for communicating with a hub capable of federating a plurality of unified communications systems.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles described herein.

FIG. 1 illustrates a block diagram of an exemplary hub-based architecture implementing a user portal and federating disparate UC systems, according to one embodiment;

FIG. 2 illustrates a screenshot of an exemplary dashboard user interface provided by the user portal, according to one embodiment;

FIG. 3 illustrates a flow diagram of an exemplary domain provisioning process using the user portal, according to one embodiment;

FIG. 4 illustrates a screenshot of an exemplary user interface for provisioning a new domain, according to one embodiment;

FIG. 5 illustrates a flow diagram of an exemplary federation process using the user portal, according to one embodiment;

FIG. 6 illustrates a screenshot of an exemplary user interface for initiating a federation link, according to one embodiment;

FIG. 7 illustrates a screenshot of an exemplary user interface for selecting domains from the domain directory, according to one embodiment;

FIG. 8 illustrates a screenshot of an exemplary federation request that includes the requester's details and comments, according to one embodiment;

FIG. 9 illustrates a screenshot of an exemplary federation readiness checklist that may be provided to the requestor and/or target administrator, according to one embodiment;

FIG. 10 illustrates a screenshot of an exemplary user portal interface for managing services, according to one embodiment;

FIG. 11 illustrates a flow diagram of an exemplary service provisioning process using the user portal, according to one embodiment;

FIG. 12 illustrates a block diagram of an exemplary user portal, according to one embodiment;

FIG. 13 illustrates a screenshot of an exemplary invitation for inviting a non-member domain to establish a federation link, according to one embodiment;

FIG. 14 illustrates a screenshot of an exemplary report generated by the reporting component, according to one embodiment;

FIG. 15 illustrates a screenshot of another exemplary report generated by the reporting component, according to one embodiment; and

FIG. 16 illustrates an exemplary computer architecture that may be used for the present system, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAIL DESCRIPTION

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

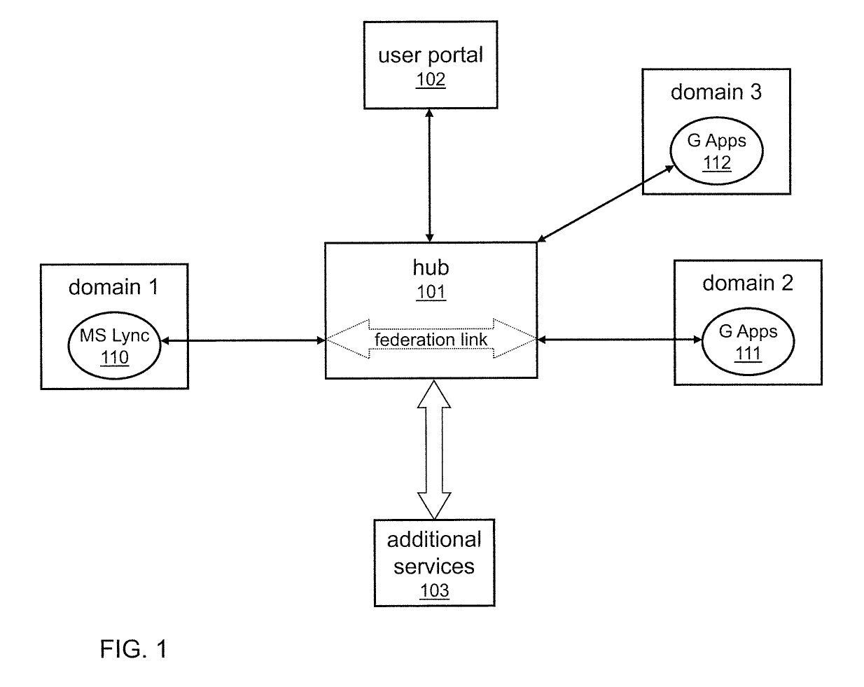

FIG. 1 illustrates a block diagram of an exemplary hub-based architecture implementing a user portal and federating disparate UC systems, according to one embodiment. The hub 101 is connected to and communicates with UC systems 110, 111, and 112 that serve their own respective domains. Although FIG. 1 only illustrates three UC systems, the hub 101 is highly-scalable and may support any number and/or type of UC systems. A new UC system (not shown in FIG. 1) that is initially not connected to the hub 101 may establish a connection with the hub 101 through a domain provisioning process. The domain provisioning process may be initiated and carried out using the user portal 102. FIG. 1 shows that the user portal 102 is connected to and communicates with the hub 101. However, it is contemplated that the user portal may be implemented as part of the hub. The user portal allows a user, typically an administrator of a UC system, to manage—including setting up, monitoring, configuring, reporting, etc. —the hub's connections with one or more UC systems and domains associated with the user's account. The user portal also allows the user to manage additional services 103 that the associated user account may be entitled to (e.g., individually paid-for services). The additional services may include Chatter, Skype, Twitter, Yammer, etc.

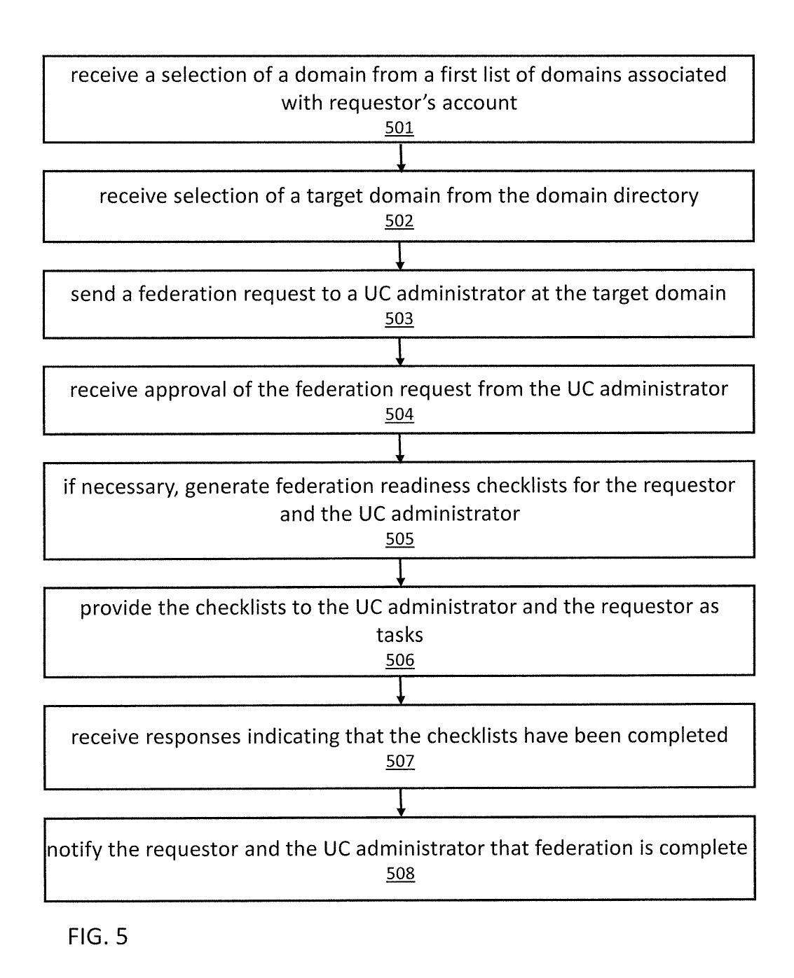

A number of third-party developers offer various UC applications for implementing UC systems. The various UC system platforms that are available include Microsoft Lync (previously, Microsoft OCS), IBM Sametime (ST), Google Apps, and Cisco Jabber. Thus, each of the UC systems 110, 111, and 112 may be of the same or different type. In this case, FIG. 1 shows that UC system 110 is running Microsoft Lync while UC systems 111 and 112 are running Google Apps. A federation link established between UC systems 110 and 111 via the hub 101 allows users on one UC system to communicate or interact with users on the other UC system as if all the users are served by the same UC system in the same or different domain. Users on disparate UC systems are otherwise generally not able to communicate with one another in this manner. For example, users on UC system 112 are not able to communicate with users on UC system 110 through their respective UC systems because no federation link has been established between them. Similar to domain provisioning with the hub 101, a user may access the user portal 102 to carry out a federation process to establish a federation link. An exemplary user-initiated federation process will be discussed below in reference to FIG. 5.

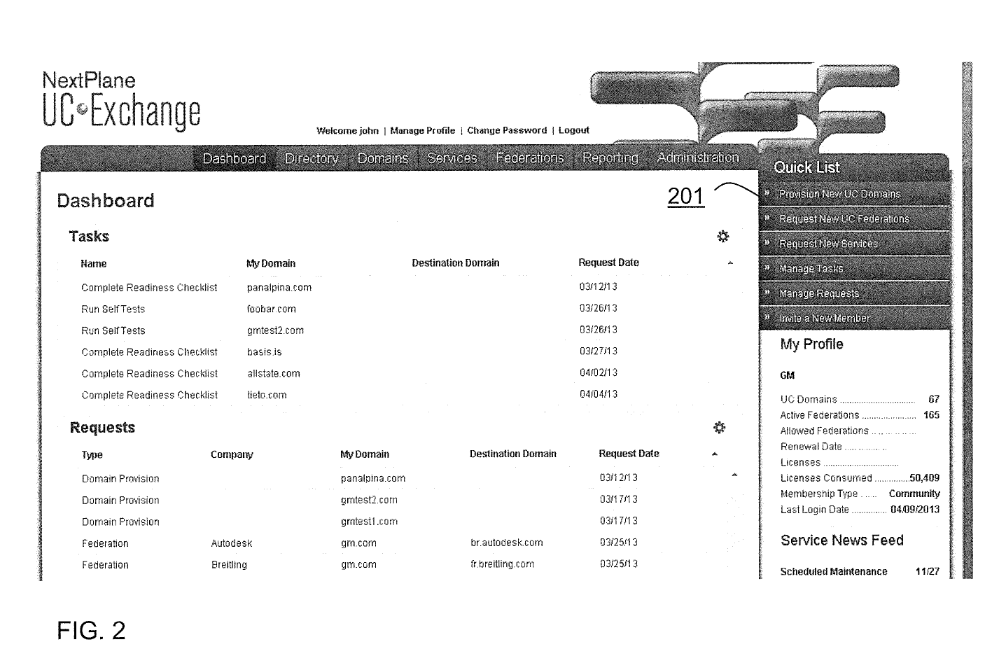

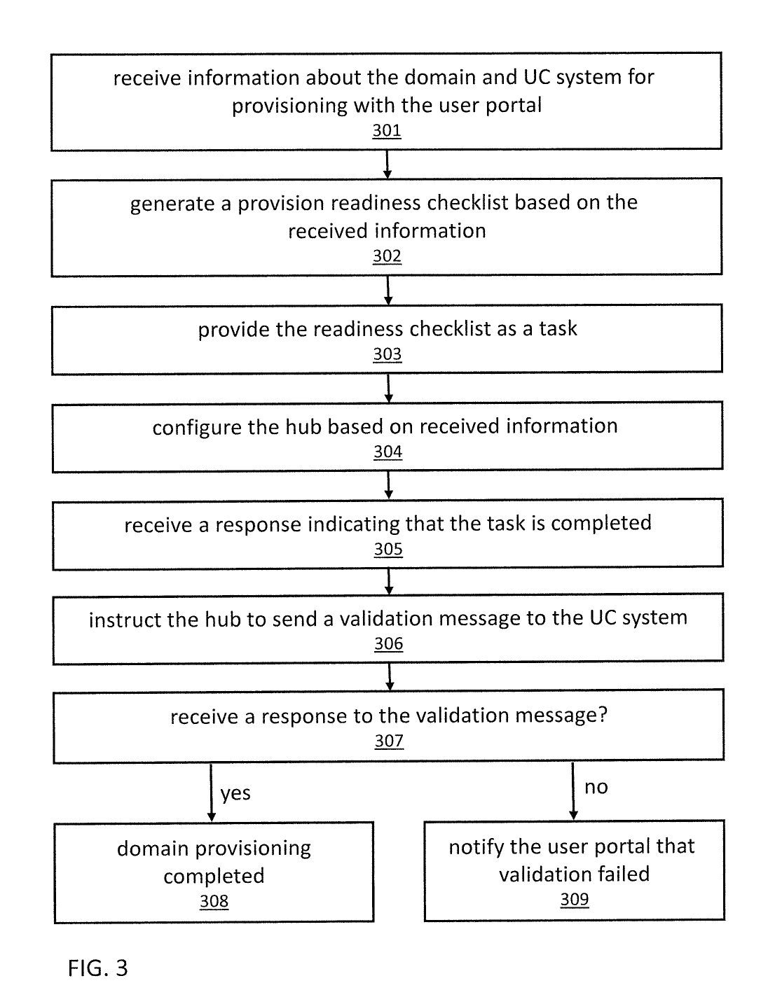

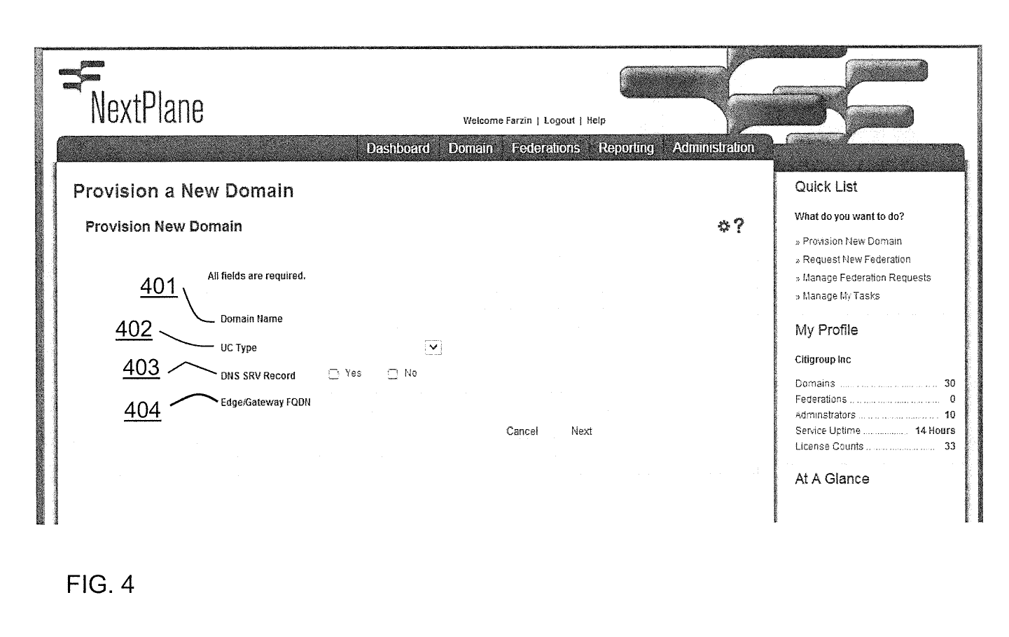

To access the user portal, a user generally has to set up an account with the user portal. After logging into the user's account, the user is provided with a user interface, such as the dashboard shown in FIG. 2. Accessing the dashboard, the user may provision a new domain such as by selecting the “Provision New Domain” option 201. FIG. 3 illustrates a flow diagram of an exemplary domain provisioning process using the user portal, according to one embodiment. After the user has set up an account with the user portal and has logged in, the user may provision one or more UC systems and their associated domains with the hub. Provisioning a domain and its associated unified communications system with the hub establishes a connection with the hub. The user initiating the provisioning service is hereafter referred to as the “provisioner.” The domain provisioning process begins with the user portal receiving information about the UC system and the domain it serves at 301. FIG. 4 illustrates a screenshot of an exemplary user interface for provisioning a new domain and shows that the information received generally includes the domain name 401, the UC system type 402, the Edge/Gateway FQDN 404, and whether there is a DNS SRV record 403.

After receiving the information regarding the UC system and its domain, the user portal generates a provision readiness checklist based on the received information at 302. The provision readiness checklist generally includes one or more required or suggested action items to be performed on the UC system side to carry out the provisioning process. The action items may, for example, include opening up a port in a firewall on the UC system side to allow communications with the hub. The provision readiness checklist is provided as a task to the provisioner, typically the administrator of the UC system being provisioned at 303. As FIG. 2 illustrates, tasks appear on the “Tasks” pane of the provisioner's dashboard when accessing the user portal. Users may also be notified of new tasks or reminded of pending tasks via other modes of communication such as by E-mail.

At 304, the user portal provides the received information to the hub and/or configures the hub based on the received information to establish a connection with the specified UC system and domain. After the user portal receives a response indicating that the action items on the provision readiness checklist have been completed at 305, the user portal instructs the hub to test its connection with the provisioning UC system by sending a validation message at 306. If a response to the validation message is received by the hub 307 from the provisioning UC system, the provisioning process is deemed to be completed 308. If a response is not received, the user portal notifies a portal administrator that validation has failed 309, at which point the portal administrator may contact the provisioner to evaluate any connection issue.

It should be noted that although certain figures presented herein, including FIG. 3, depict operations being performed in a sequential manner, a person of ordinary skill in the art would appreciate that one or more operations may be performed concurrently with or prior to other operations. For example, referring to FIG. 3, a person of ordinary skill in the art would appreciate that 303 may be performed concurrently with 304 and that 305 may be performed prior to 304. Such modifications are contemplated and within the scope of the present disclosure.

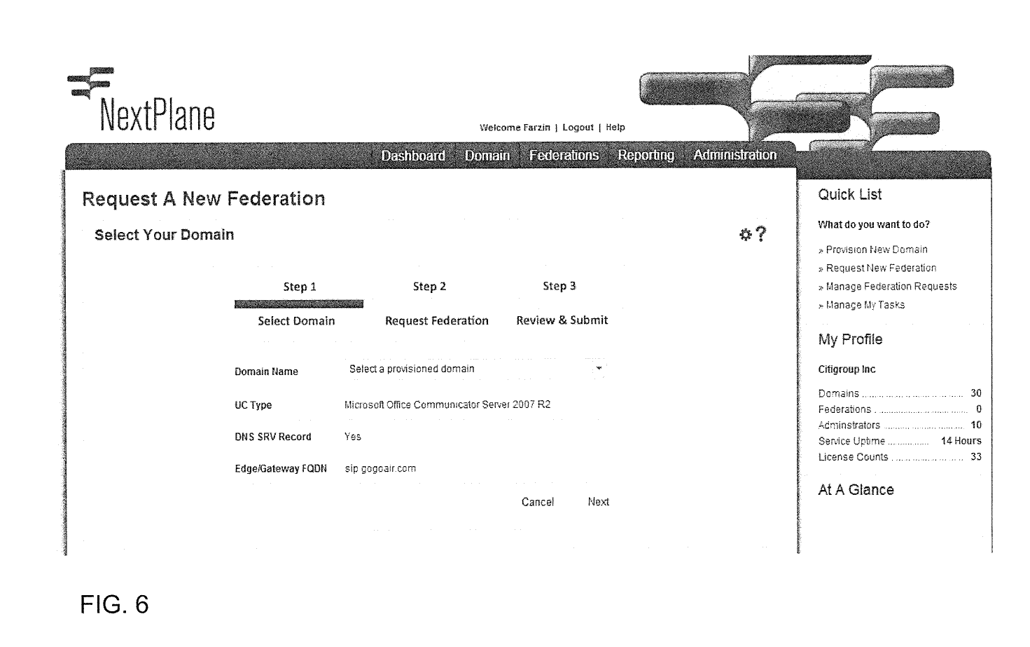

After a domain has been provisioned with the hub, the UC system associated with that domain is operatively connected to and able to communicate with the hub. However, as discussed earlier in relation to FIG. 1, if users on a UC system serving one domain desire to communicate with users on a disparate UC system serving another domain, a federation link has to be established between the two UC systems. A user may access the user portal 102 to carry out a federation process to establish a federation link. The user initiating the federation process is hereafter referred to as the “requestor.” FIG. 5 illustrates a flow diagram of an exemplary federation process using the user portal, according to one embodiment. The federation process begins with the user portal receiving the requestor's selection of a requesting domain that is associated with the requestor's account at 501. The requesting domain is the domain that the requestor desires to create a federation link for. FIG. 6 illustrates that the requesting domain may be selected from a drop down list of domains associated with the requestor's account. The list of domains generally represents the domains that have already been provisioned with the hub.

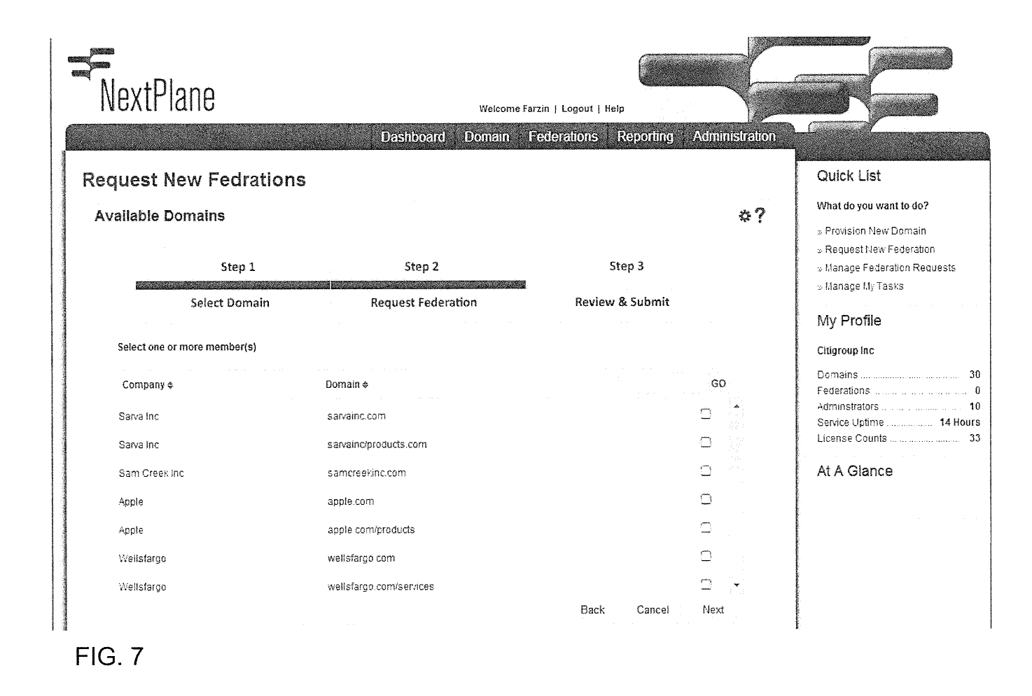

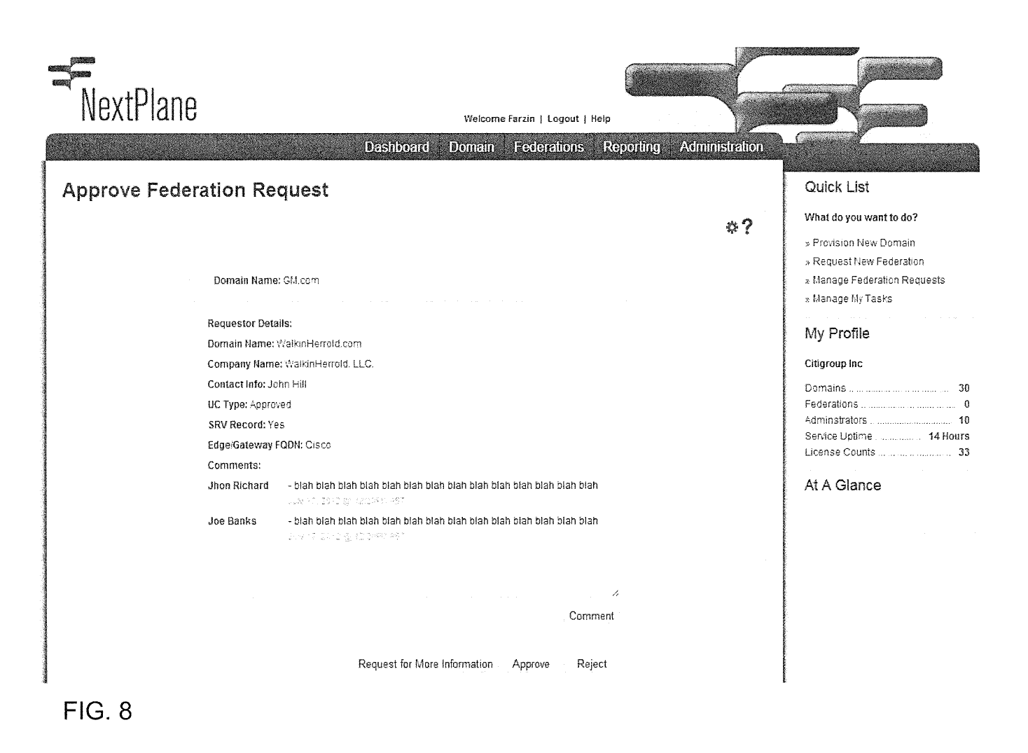

Next, the user portal receives the requestor's selection of a target domain from the domain directory at 502. The target domain is the domain that the requestor wishes to create a federation link with the requesting domain. FIG. 7 illustrates a screenshot of an exemplary directory of domains that are available for federation and from which the requestor may select a target domain. Because the target domain is usually owned and operated by another user or entity that is not associated with the requestor, a federation request is usually sent to an administrator (“target administrator”) of the UC system serving the target domain at 503. It is contemplated that in some cases a federation request may not be necessary, such as if the target UC system is configured to allow open federation. FIG. 8 illustrates a screenshot of an exemplary federation request that includes the requester's details and comments.

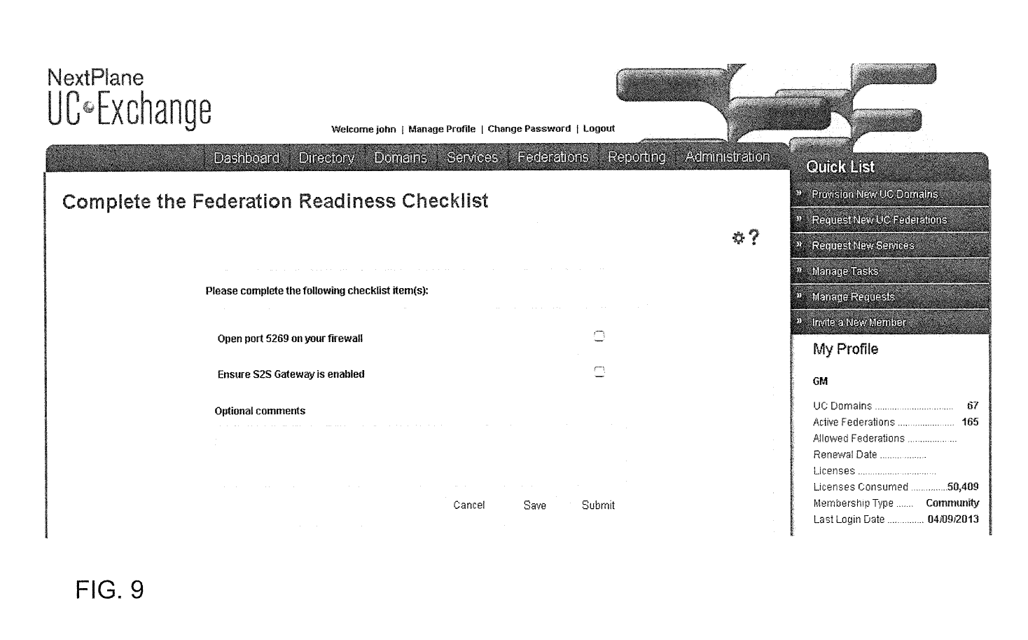

After the user portal receives approval of the federation request at 504, the user portal determines whether a federation readiness checklist should be generated for each of the requestor and the target administrator at 505. A federation readiness checklist for the requestor generally includes one or more required or suggested action items that should be performed by the requestor. Similarly, a federation readiness checklist for the target administrator generally includes one or more required or suggested action items that should be performed by the target administrator. Whether a federation readiness checklist should be generated for each of the requestor and the target administrator depends on the specifics (e.g, protocol type/configuration) of their respective UC systems. For example, if the requesting domain's UC system is running Microsoft Lync, the requestor's federation readiness checklist may instruct the requestor to publish an SRV record specifying the hub's address in the FQDN field in order to redirect SIP traffic intended for the requesting domain to the hub. Similarly, if the target domain's UC system is running Google Apps, the requestor's federation readiness checklist may instruct the target administrator to publish an SRV record with the hub's address in the FQDN field in order to redirect XMPP traffic intended for the target UC system to the hub. If federation readiness checklists are generated, they are provided to the requester and/or target administrator respectively as tasks at 506. FIG. 9 illustrates a screenshot of an exemplary federation readiness checklist that may be provided to the requestor and/or target administrator according to one embodiment. After completing their respective tasks, the requestor and/or target administrator may send responses to the user portal indicating that the checklists have been completed at 507, such as by checking off the action items and saving the readiness checklist shown in FIG. 9. At 508, the federation process between the requesting domain and the target domain is complete and the requestor and the target administrator are notified of the completion.

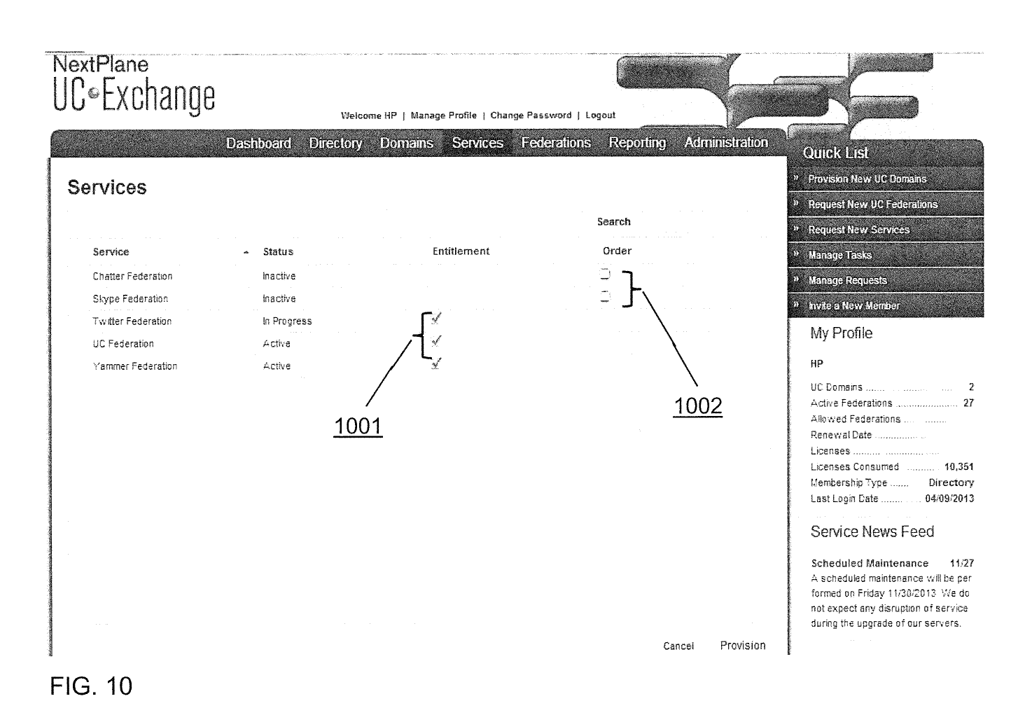

In addition to provisioning domains and establishing federation links as described above, the user portal also allows the user to provision other services supported by the hub. Provisioning a service for a domain allows users in the domain to access the service via the hub. These other services may be third-party services such as Chatter, Skype, Twitter, Yammer, etc. FIG. 10 illustrates a screenshot of an exemplary user portal interface that allows the user to manage services supported by the hub, according to one embodiment. Depending on the user's account status, the user may be entitled to certain services and not others. The user is generally entitled to paid-for services. FIG. 10 illustrates that the user is entitled to Twitter federation, UC federation, and Yammer federation services but not Chatter federation and Skype federation services. The user may choose to provision services that he is already entitled to by selecting the corresponding checkboxes 1001. If the user desires to provision services that he is not entitled to, the user may order those services by selecting the corresponding checkboxes 1002.

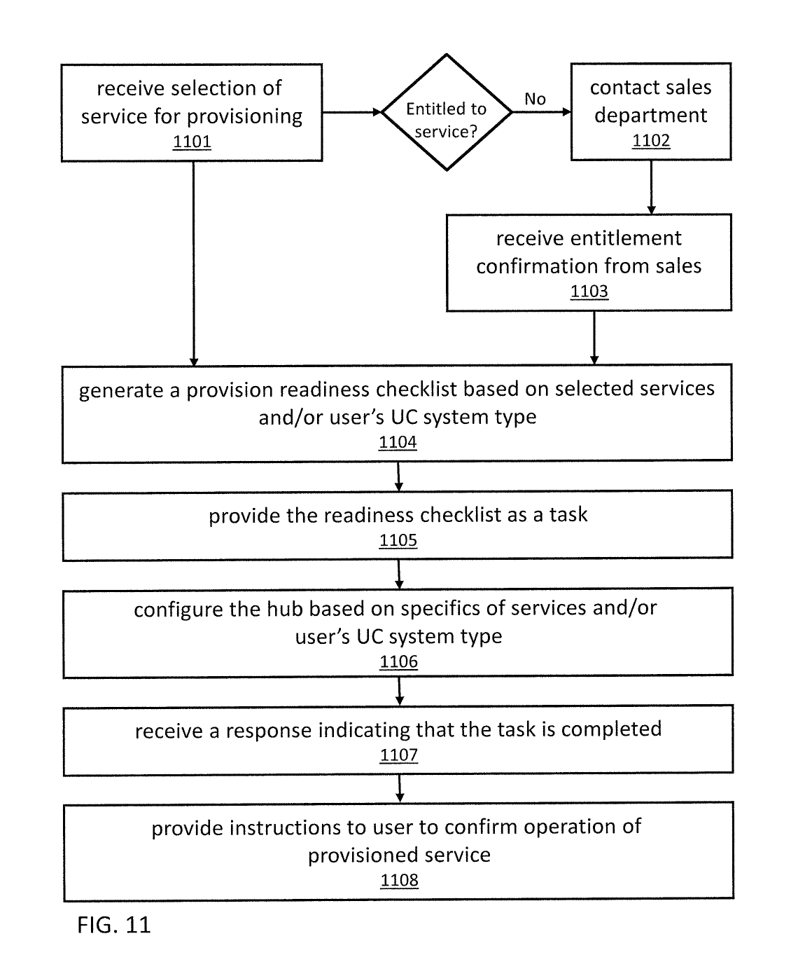

FIG. 11 illustrates a flow diagram of an exemplary service provisioning process using the user portal, according to one embodiment. The service provisioning process begins with the user portal receiving the user's selection of one or more services at 1101. After receiving the user's selection, the user portal determines whether the user is entitled to the selected services. If the user is not entitled to a selected service, the user portal may notify the sales department at 1102. The sales department may contact the user to resolve payments for the service. If the user is entitled to the selected services or if the user portal receives authorization for the ordered services, such as from the sales department, at 1103, the user portal generates a provision readiness checklist based on the specifics (e.g., type, configuration, etc.) of the selected services and/or the user's UC system at 1104. The provision readiness checklist generally includes one or more required or suggested action items to be performed on the UC system side to carry out the provisioning process for the selected services. The action items may, for example, include setting the port number to use with the service. The provision readiness checklist is provided as a task to the user who initiated the provisioning process at 1105.

At 1106, the user portal configures the hub based on the specifics of the selected services and/or the user's UC system type to provide the selected services. After the user portal receives a response indicating that the items on the provision readiness checklist have been completed at 1107, the user portal may instruct the user to confirm the operation of the newly provisioned services at 1108. For example, the user portal may instruct the user to establish communications with a bot (e.g., adding an echo bot to user's contact list) and to exchange messages with the bot.

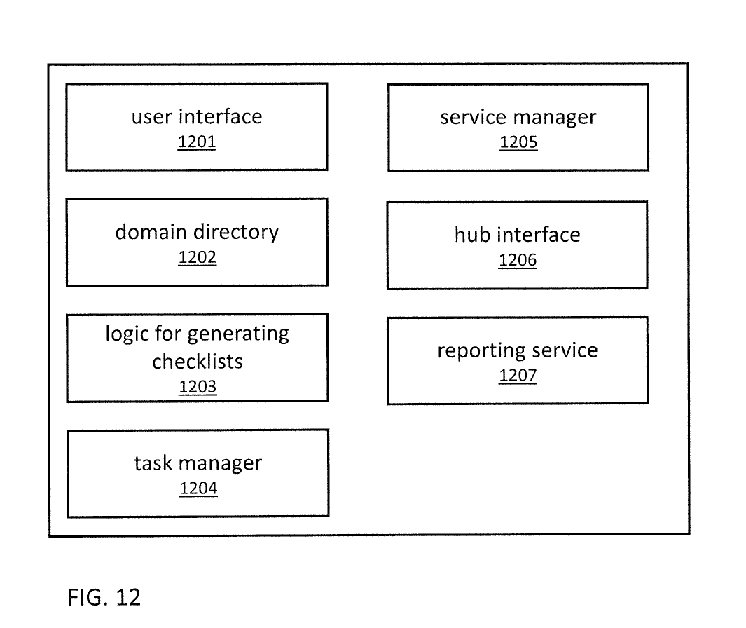

FIG. 12 illustrates a block diagram of an exemplary user portal, according to one embodiment. The user portal includes: a user interface component 1201, a domain directory 1202, a logic component 1203 for generating readiness checklists, a task manager 1204, a service manager 1205, a hub interface component 1206, and a reporting component 1207. It is contemplated that these components may be combined or divided into sub-components and that the user portal or its components may be implemented using software elements, hardware elements, or a combination of software and hardware elements. Such variations are within the scope of the current disclosure.

The user interface component 1201 provides a user interface that allows a user to interact and communicate with the user portal. Features available to the user through the user interface may vary depending on the permissions associated with the user's account (e.g., community member, sponsored member, portal administrator, etc.) Also, the look and feel of the user interface provided to the user may be customizable to suit the user. The customization may be based on the user's account profile, preferences, and/or associations. For example, if one user is an employee of company A, the user interface provided may look and feel like a user interface provided by company A. If another user is an employee of company B, the user interface may look and feel like a user interface provided by company B. Thus, while the user portal may provide the same or similar features for each user, the look and feel of the user interface may be customized per user or user group. According to one embodiment, the customization may also depend on a set of customers who are members of the user portal (or hub) by virtue of being customers of a partner of the company running the hub and user portal. The customization allows a set of customers to be part of the larger underlying clearinghouse even though they may appear to be part of a smaller virtual clearinghouse affiliated to the partner.

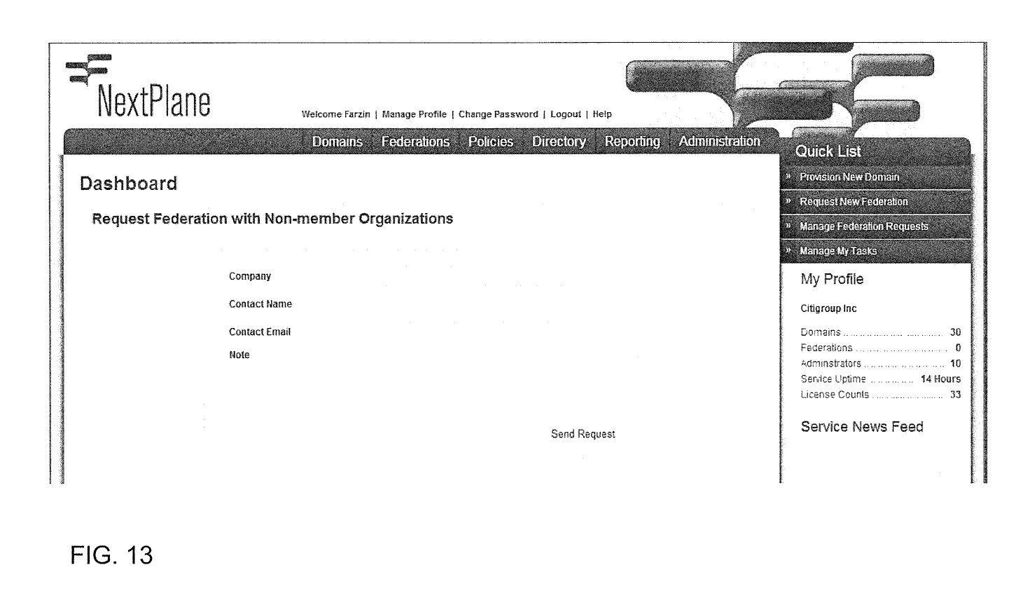

The domain directory 1202 is a directory of provisioned domains that are available for federation. Generally, after a new domain has been provisioned with the hub, the newly provisioned domain is included as a member in the domain directory unless the user, typically an administrator, of the newly provisioned domain opts out of being included in the directory. Members included in the domain directory may be community members or directory members. Community members are generally paying members who are permitted to request and accept federation with other members. Directory members are generally non-paying members who are permitted to accept federation requests but are not permitted to request federation with other members. Additionally, a directory member may be a sponsored or non-sponsored member. A sponsored member is a member who has joined and provisioned with the hub because a community member has requested federation with the sponsored member. A non-sponsored member is a member who may have been invited to join and provision with the hub even though federation has not been requested. If a domain is not listed in the domain directory, the user who desires to establish a federation link with the unlisted domain may send an invitation, such as one shown in FIG. 13, by specifying the contact information associated with the unlisted domain.

The logic component 1203 includes logic for generating both provision readiness checklists and federation readiness checklists. As discussed earlier in regards to the provisioning process, the user portal includes logic to determine whether and how the UC system has to be configured in order to establish communication with the hub. Based on the specifics of the UC system being provisioned, the logic component 1203 may generate a list of one or more required or suggestive action items to be performed, such as by the provisioner, to carry out the provisioning process. The items may, for example, include configuring the provisioning UC system's firewall to allow communications with the hub. In generating the provisioning readiness checklist, the logic component 1203 may also take into account any additional services (e.g., Chatter, Skype, Twitter, Yammer, etc.) associated with the provisioner's account. The generated provision readiness checklist may include instructions on how to perform the items.

The logic component 1203 also generates federation readiness checklists in a similar fashion. Based on the specifics of the requestor's UC system and/or that of the target UC system, the logic component 1203 may generate a list of one or more required or suggestive action items to be performed by the requestor and/or a list of one or more required or suggestive action items to be performed by the target administrator. In generating the federation readiness checklist, the logic component 1203 may also take into account any additional services (e.g., Chatter, Skype, Twitter, Yammer, etc.) associated with the requestor's or target administrator's account. Again, each of the federation readiness checklists may include instructions on how to perform the action items. In addition to generating readiness checklists during the provisioning and federation processes, the logic component 1203 may also be called on to generate new readiness checklists (provisioning or federation) if certain parameters of provisioned or federated UC systems have changed. Administrators of the UC systems affected by the modifications are then notified of the new readiness checklists.

Tasks that have been assigned to the user, such as provision and federation readiness checklists, are managed by the task manager 1204. Managing a task includes, but is not limited to, creating the task, monitoring the task, updating the user or a third-party on the status of the task, and discarding or modifying the task. As FIG. 2 illustrates, the user may access and view his tasks via the dashboard user interface. Users may also be notified of new tasks or reminded of pending tasks via other modes of communication such as by E-mail.

The service manager 1205 manages services that are supported by the hub and that may be made available to the user through the provisioning process discussed above. The service manager determines which services are entitled to the user based on the user's account status, such has whether the user has already paid for the service. If the user requests to provision a service that the service manager determines the user is not entitled to, the service manager may facilitate the user to order the service, such as by contacting the sales department.

The hub interface component 1206 enables the user portal and its users to communicate with the hub, such as to provide information for configuring the hub and to retrieve information from the hub. For example, users, typically administrators of provisioned UC systems, can configure the hub by setting and enforcing policies to control inter-domain communication via the user portal. To illustrate, an administrator may administer a policy through the hub to restrict inter-domain communication between users or groups of users in different domains. Or the administrator may administer a policy to automatically attach predetermined message content, such as a legal disclaimer, to all or certain inter-domain communications between users or groups of users in different domains. Such granular control in setting and enforcing policies allows administrators of UC systems to flexibly and efficiently manage communication risks that may arise.

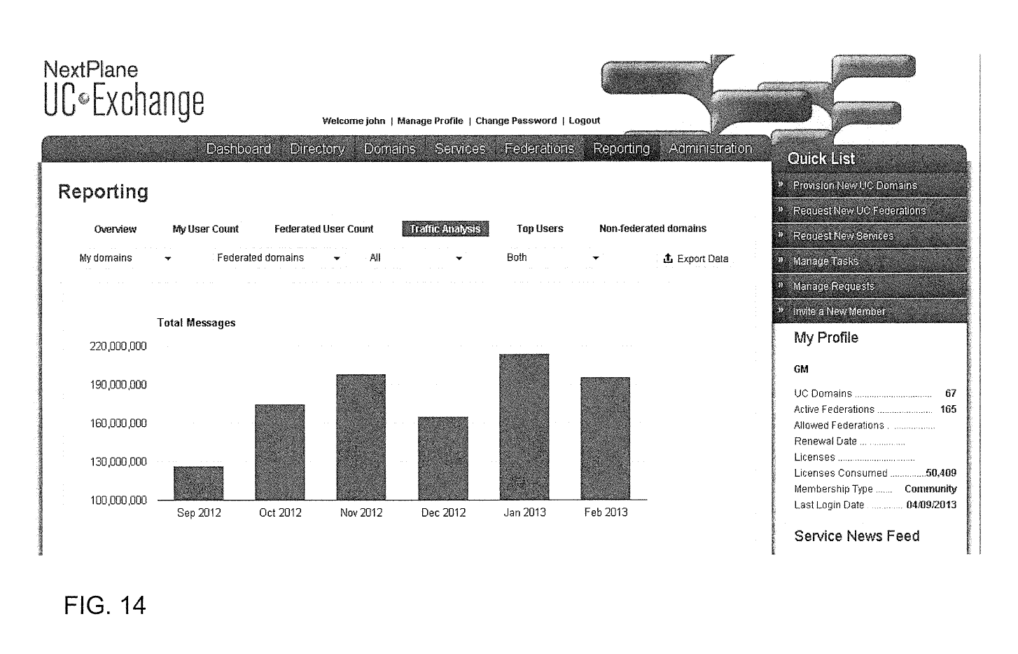

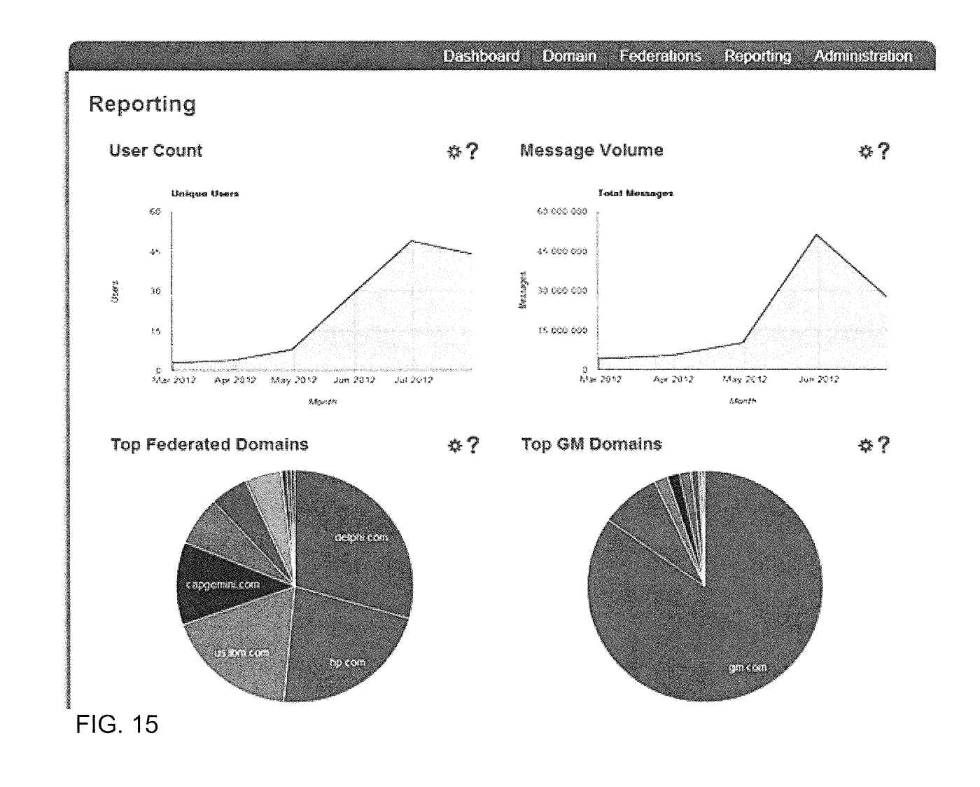

The reporting service component 1207 provides services for monitoring, statistical analysis, and reporting of inter-domain communications traffic between domains associated with the user's account and other domains. FIG. 14 illustrates a screenshot of an exemplary report generated by the reporting service component that describes the user count in the domains over a period of time. FIG. 15 illustrates another screenshot of an exemplary report generated by the reporting service component that describes the user count, the message volume, and the most utilized federated domains over a period of time. In addition to reporting historical data and statistics, the reporting component 1207 is also capable of generating reports based on real-time or substantially real-time data.

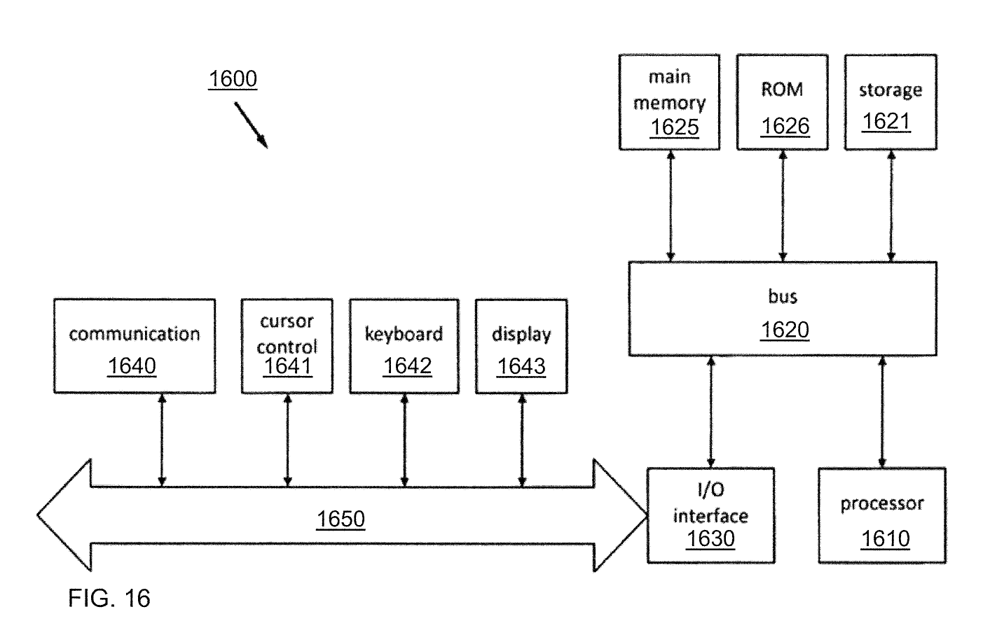

FIG. 16 illustrates an exemplary computer architecture that may be used for the present system, according to one embodiment. The exemplary computer architecture may used for implementing one or more components described in the present disclosure including, but not limited to, the user portal. One embodiment of architecture 1600 comprises a system bus 1620 for communicating information, and a processor 1610 coupled to bus 1620 for processing information. Architecture 1600 further comprises a random access memory (RAM) or other dynamic storage device 1625 (referred to herein as main memory), coupled to bus 1620 for storing information and instructions to be executed by processor 1610. Main memory 1625 also may be used for storing temporary variables or other intermediate information during execution of instructions by processor 1610. Architecture 1600 may also include a read only memory (ROM) and/or other static storage device 1626 coupled to bus 1620 for storing static information and instructions used by processor 1610.

A data storage device 1625 such as a magnetic disk or optical disc and its corresponding drive may also be coupled to architecture 1600 for storing information and instructions. Architecture 1600 can also be coupled to a second I/O bus 1650 via an I/O interface 1630. A plurality of I/O devices may be coupled to I/O bus 1650, including a display device 1643, an input device (e.g., an alphanumeric input device 1642 and/or a cursor control device 1641).

The communication device 1640 allows for access to other computers (e.g., servers or clients) via a network. The communication device 1640 may comprise one or more modems, network interface cards, wireless network interfaces or other interface devices, such as those used for coupling to Ethernet, token ring, or other types of networks.

The advantages of the system disclosed herein are readily apparent. The present system facilitates federating multiple, disparate UC systems in an efficient manner by enabling users, typically administrators of the UC systems, to initiate and carry out the provisioning and federating processes.

We claim:

1. An apparatus for managing connections of a hub-based federation system, the apparatus comprising:
a user interface for receiving input from a user;
a logic component for generating a checklist of action items based on the user input;
a task manager for managing the checklist as a task; and
a hub interface for communicating with a hub capable of federating a plurality of unified communications systems.

2. The apparatus of claim 1, wherein receiving input from a user includes receiving a request to provision a domain associated with a unified communications system.

3. The apparatus of claim 2, wherein generating a checklist of action items includes generating a domain provision readiness checklist based on the type of the unified communications system.

4. The apparatus of claim 2, wherein communicating with the hub includes configuring the hub to establish a connection with the unified communications system.

5. The apparatus of claim 2, wherein managing the checklist as a task includes providing the checklist as a task to the user.

6. The apparatus of claim 2, wherein communicating with the hub includes instructing the hub to send a validation message to the unified communications system when the task manager receives an indication that action items on the generated checklist have been completed.

7. The apparatus of claim 1, wherein receiving input from a user includes receiving a request to establish federation link between a first unified communications system and a second unified communications system.

8. The apparatus of claim 7, wherein generating a checklist of action items includes:
generating a first federation readiness checklist based on the type of the first unified communications system; and
generating a second federation readiness checklist based on the type of the second unified communications system.

9. The apparatus of claim 8, wherein managing the checklist as a task includes:
providing the first federation readiness checklist as a task to the user; and
providing the second federation readiness checklist as a task to an administrator of the second unified communications system.

10. The apparatus of claim 7, wherein communicating with the hub includes configuring the hub to establish a federation link between the first and second unified communications systems.

11. The apparatus of claim 1, wherein receiving input from a user includes receiving a request to provision a service for a domain associated with the user.

12. The apparatus of claim 11 further comprising a service manager for determining whether the user is entitled to the service.

13. The apparatus of claim 11, wherein generating a checklist of action items includes generating a service provision checklist based on the type of the service.

14. The apparatus of claim 11, wherein communicating with the hub includes configuring the hub to enable the service for the domain.

15. The apparatus of claim 1, wherein communicating with the hub includes administering a policy to restrict inter-domain communications between users in a first domain and users in a second domain.

16. The apparatus of claim 1, wherein communicating with the hub includes administering a policy to automatically attach predetermined message content to inter-domain between users in a first domain and users in a second domain.

17. The apparatus of claim 1, wherein the appearance of the user interface is customizable based on the user's association.

18. A method for managing connections of a hub-based federation system, the method comprising:
receiving input from a user;
generating a checklist of action items based on the received user input;
managing the checklist as a task; and
communicating with a hub capable of federating a plurality of unified communications systems.

19. The method of claim 18, wherein receiving input from a user includes receiving a request to provision a domain associated with a unified communications system.

20. The method of claim 19, wherein generating a checklist of action items includes generating a domain provision readiness checklist based on the type of the unified communications system.

21. The method of claim 19, wherein communicating with the hub includes configuring the hub to establish a connection with the unified communications system.

22. The method of claim 19, wherein managing the checklist as a task includes providing the checklist as a task to the user.

23. The method of claim 19, wherein communicating with the hub includes instructing the hub to send a validation message to the unified communications system after receiving an indication that action items on the generated checklist have been completed.

24. The method of claim 18, wherein receiving input from a user includes receiving a request to establish federation link between a first unified communications system and a second unified communications system.

25. The method of claim 24, wherein generating a checklist of action items includes:
generating a first federation readiness checklist based on the type of the first unified communications system; and
generating a second federation readiness checklist based on the type of the second unified communications system.

26. The method of claim 25, wherein managing the checklist as a task includes:
providing the first federation readiness checklist as a task for the user; and
providing the second federation readiness checklist as a task for an administrator of the second unified communications system.

27. The method of claim 24, wherein communicating with the hub includes configuring the hub to establish a federation link between the first and second unified communications systems.

28. The method of claim 18, wherein communicating with the user includes receiving a request to provision a service for a domain associated with the user.

29. The method of claim 28 further comprising determining whether the user is entitled to the service.

30. The method of claim 28, wherein generating a checklist of action items includes generating a service provision checklist based on the type of the service.

31. The method of claim 28, wherein communicating with the hub includes configuring the hub to enable the service for the domain.

32. The method of claim 1, wherein communicating with the hub includes administering a policy to restrict inter-domain communications between users in a first domain and users in a second domain.

33. The method of claim 1, wherein communicating with the hub includes administering a policy to automatically attach predetermined message content to inter-domain between users in a first domain and users in a second domain.
